(19) United States
(12) Patent Application Publication
(10) Pub. No.: US 2024/0363885 A1
(43) Pub. Date: Oct. 31, 2024

(54) BATTERY CELL STACK PRODUCTION METHOD, BATTERY CELL STACK PRODUCTION APPARATUS AND COMPUTER PROGRAM

(71) Applicant: GROB-WERKE GmbH & Co. KG, MINDELHEIM (DE)

(72) Inventors: Thomas PFITZMAIER, USTERSBACH (DE); Jürgen PAUL, LOPPENHAUSEN (DE); Alexander FRITZ, SCHIESSEN (DE)

(21) Appl. No.: 18/648,044

(22) Filed: Apr. 26, 2024

(30) Foreign Application Priority Data
Apr. 27, 2023 (DE) 102023110844.1
Jul. 7, 2023 (EP) 23184280.8

(51) Int. Cl. H01M 10/04

(52) U.S. Cl. CPC H01M 10/0404; H01M 10/04

(57) ABSTRACT

Methods and apparatuses for producing battery cell stacks in which a first and second electrode string with separator web and first and second electrodes attached thereto at a distance are combined together to form a composite string and mono-cells are separated therefrom. To form terminal cells, a second electrode is omitted in each case at some locations during the production of the second electrode string, so that a length section of the respective separator web is produced without the corresponding second electrode. A terminal cell region is then formed in the composite string, in which a first electrode is inserted between separator web length sections. This is separated when the cells are separated from the composite string to form a terminal cell. Subsequent stacking can then begin or terminate with an end cell. Also a computer program for performing the method.

### CROSS-REFERENCES TO RELATED APPLICATIONS

This application claims the benefit of German Patent Application Number 10 2023 110 844.1 filed on Apr. 27, 2023, and European Patent Application Number 23 184 280.8 filed on Jul. 7, 2023 the entire disclosures of which are incorporated herein by way of reference.

### FIELD OF THE INVENTION

The invention relates to a battery cell stack production method for the production of battery cell stacks. The invention further relates to a battery cell stack production apparatus for the production of battery cell stacks and a computer program therefor.

The invention relates in particular to the field of automated and computer-controlled production of mono-cells and battery stacks from such mono-cells.

### BACKGROUND OF THE INVENTION

For the technological background reference is made to the following literature:
[1] WO 2020/192 845 A1
[2] DE 10 2017 216 156 A1

Methods and apparatuses for the provision of electrode strings and for the production of mono-cells and battery stacks formed from them are known from [1]. In particular, [1] describes a system for the production of battery cells in which an anode string with anodes (A) attached to a first web-shaped separator (S) and a cathode string with cathodes (K) attached to a second web-shaped separator (S) are provided as electrode strings from which a string composite is formed from which mono-cells are separated. In contrast to the process of Z-folding battery cells, this is a continuous process. The advantage here is the higher output due to a continuous process. For this purpose, separator, anode, separator, cathode (SASK) are laminated together in the system in this sequence. The basis of the battery cell is created by stacking individual SASK layers.

Document [2] describes a method for the production of mono cells in which the separator is first sucked onto a vacuum belt. At the same time, electrodes are sucked onto a drum and separated by a laser. The separated electrode is transferred to the separator and sucked through it onto the vacuum belt. A second separator is applied to this and then transferred to a transport system with individually moving transport units on a guide track (sometimes also called a mover system). Here, the separator web is cut and another electrode, which is provided in the same way as the first, is placed on top. The pack is mechanically clamped and transported to the discharge point.

### SUMMARY OF THE INVENTION

The invention is based on the problem of providing improved methods and apparatuses for the production of battery cell stacks formed from mono-cells in industrial mass production in terms of process time, effort and process control.

To solve this problem, the invention provides a battery cell stack production method according to one or more embodiments described herein, as well as a battery cell stack production apparatus according to one or more embodiments described herein. A computer program according to one or more embodiments described herein is also disclosed herein.

According to one aspect, the invention provides a battery cell stack production method for the production of battery cell stacks, the method comprising:
a) producing a first electrode string, wherein first electrodes are fixed to a first separator web at a predetermined distance from each other to form a series of consecutive first electrode half-cell sections having a predetermined length, so that each first electrode half-cell section is formed of a length section of the first separator web and a first electrode,
b) producing a second electrode string, wherein second electrodes, which are counter electrodes to the first electrodes, are fixed to a second separator web at a predetermined distance from each other to form a series of second electrode half-cell sections having the same predetermined length as the first electrode half-cell sections, so that each second electrode half-cell section is formed from a length section of the second separator web and a second electrode,
c) forming a cell composite string by aligning and attaching the first electrode string and the second electrode string to each other such that a first electrode half-cell section and a second electrode half-cell section are placed on top of each other in successive length sections in the cell composite string to form a series of mono-cell regions, each having a layered structure of a length section of one of the first and second separator webs, one of the first and second electrodes, a length section of the other of the first and second separator webs and the other of the first and second electrodes,
d) separating the length sections of the cell composite string to separate the mono-cell regions into mono-cells having a layered structure of separator, one of the first and second electrodes, separator and the other of the first and second electrodes, and
e) stacking a plurality of mono-cells on top of each other to form a battery cell stack having a repeating layered structure of separator—one of the first and second electrodes—separator—other of the first and second electrodes, wherein step b) comprises:
b1) omitting a second electrode at a plurality of locations so as to respectively form an empty section having the same predetermined length as the first electrode half-cell section formed from a length section of the second separator web without the second electrode, wherein step c) comprises:
c1) aligning each empty section with a first electrode half-cell section so that a terminal cell region is formed in the cell composite string at each of the plurality of locations, which terminal cell region has a layered structure comprising the length section of the first separator web, the first electrode and the length section of the second separator web, but no second electrode, wherein step d) comprises:
d1) separating the terminal cell regions from the cell composite string to obtain terminal cells having a layered structure of separator, first electrode and separator, and wherein step e) comprises:
beginning or ending stacking with a terminal cell obtained in step d1) so that each battery cell stack terminates at each end with a first electrode and a separator.

Preferably, step e) comprises the step:
e1) forming a plurality of battery cell stacks at a plurality of stacking locations which are arranged one behind the other in a transport direction of the mono and terminal cells.

Preferably, step e) comprises the step:
e2) beginning each battery cell stack with a terminal cell.

Preferably, step e) comprises the step:
e3) detecting the number of cells at each stack location.

Preferably, step b1) comprises the step:
b1a) flexibly generating an empty section in response to a control command.

Preferably, step b1) comprises the step:
b1b) generating empty sections depending on a number of cells in one or more of the battery cell stacks created in step e).

Preferably, step b1) comprises the step:
b1c) generating empty sections depending on a filling level of stack locations.

It is preferred that step b) comprises providing the second electrodes by separating them from a web-shaped second electrode substrate and that step a) comprises providing the first electrodes by separating them from a web-shaped first electrode substrate and that a speed at which the web-shaped second electrode substrate is supplied for providing the second electrodes is lower than a speed at which the web-shaped first electrode substrate is supplied for providing the first electrodes.

It is preferred that step b) comprises:
b2) providing the second electrodes by means of a flexible second-electrode transport system which has transport units that can be moved individually along a guide track, on each of which a second electrode is transported,
and in that step b1) comprises:
b2.1) holding back a transport unit to form the empty section.

It is preferred that step b) comprises the following sequence of steps:
b-a) providing a web-shaped second-electrode substrate;
b-b) picking up the web-shaped second-electrode substrate by means of the second-electrode transport system and transporting the second-electrode substrate to a second-electrode cutting device;
b-c) cutting the web-shaped second-electrode substrate in the second-electrode cutting device to cut off second electrodes, each of which is individually arranged on one of the transport units;
b-d) adjusting a distance between cut second electrodes by means of relative movement of the transport units to position the second electrodes relative to each other;
b-e) providing the second separator web;
b-f) applying and fixing the second electrodes positioned relative to each other on the second separator web.

It is preferred that step a) comprises the following sequence of steps:
a-a) providing a web-shaped first-electrode substrate;
a-b) picking up the web-shaped first-electrode substrate by means of a flexible first-electrode transport system which has transport units individually movable along a guide track, and transporting the first electrode substrate to a first electrode cutting device;
a-c) cutting the web-shaped first electrode substrate in the first-electrode cutting device to cut off first electrodes, each of which is individually arranged on one of the transport units of the first-electrode transport system;
a-d) adjusting a distance between cut first electrodes by means of relative movement of the transport units to position the first electrodes relative to each other;
a-e) providing the first separator web;
a-f) applying to and fixing the first electrodes positioned relative to each other on the first separator web.

In some embodiments, the first electrodes are anodes and the second electrodes are cathodes. In other embodiments, the first electrodes are cathodes and the second electrodes are anodes.

According to a further aspect, the invention provides a battery cell stack production apparatus for the production battery cell stacks, the apparatus comprising:
a computer-controlled first electrode string production device for producing a first electrode string, the first electrode string production device being adapted to attach first electrodes to a first separator web at a predetermined distance from each other to form a series of successive first electrode half-cell sections having a predetermined length such that each first electrode half-cell section is formed of a length section of the first separator and a first electrode,
a computer-controlled second electrode string production device for producing a second electrode string, the second electrode string production device being adapted to attach to a second separator web second electrodes, which are counter electrodes to the first electrodes, at a predetermined distance from each other to form a series of second electrode half-cell sections having the same predetermined length as the first electrode half-cell sections, so that each second electrode half-cell section is formed of a length section of the second separator web and a second electrode,
a computer-controlled string connecting device adapted to form a composite cell string by aligning and attaching the first electrode string and the second electrode string to each other such that a first electrode half-cell section and a second electrode half-cell section are superposed in successive length sections in the composite cell string to form a series of mono-cell regions, each having a layered structure of a length section of one of the first and second separator webs, one of the first and second electrodes, a length section of the other of the first and second separator webs and the other of the first and second electrodes,
a cell composite separating device for separating the length sections of the cell composite string to separate the mono-cell regions into mono-cells having a layered structure of separator, one of the first and second separator webs, separator and the other of the first and second electrodes, and
a computer-controlled stacking device which is designed to stack a plurality of mono-cells on top of one another in order to form a battery cell stack with a repeating layer structure of separator—one of the first and second electrodes—separator—other of the first and second electrodes,
wherein the second electrode string production device is adapted to omit a second electrode at a plurality of locations so that an empty section having the same predetermined length as the first electrode half-cell section formed from a length section of the second separator web without the second electrode is created, respectively,
wherein the string connecting device is designed to align each empty section with a first electrode half-cell section, so that a terminal cell section is formed in the cell composite string at each of the plurality of locations, which terminal cell section has a layered structure comprising the length section of the first separator web, the first electrode and the length section of the second separator web, but no second electrode,
wherein the cell composite separating device is adapted to separate the terminal cell regions from the cell composite string to obtain terminal cells having a layered structure of separator, first electrode and separator, and
wherein the stacking device is adapted to begin or end the stacking of each stack of cells with a terminal cell so that each stack of battery cells terminates at each end with a first electrode and a separator.

It is preferred that the stacking device has several stacking locations arranged one behind the other in a transport direction of the mono and terminal cells.

It is preferred that the stacking device has a cell detection and counting device for detecting the number of cells at one or more stacking locations.

Preferably, the second electrode string production device is designed to flexibly generate an empty section in response to a control command.

Preferably, the second electrode string production device is designed to generate empty sections depending on a number of cells in one or more of the battery cell stacks formed by the stacking device.

Preferably, the second electrode string production device is designed to generate empty sections as a function of a filling level of stacking locations of the stacking device.

It is preferred that the first electrode string production device has a first electrode web delivery device for delivering a web-shaped first electrode substrate, and the second electrode string production device has a second electrode web delivery device for delivering a web-shaped second electrode substrate, wherein the first electrode string production device and the second electrode string production device are controlled such that the first electrode substrate is delivered at a higher speed than the second electrode substrate.

It is preferable that the second electrode string production device has a flexible second-electrode transport system with transport units that can be moved individually along a guide track for transporting a second electrode in each case and is configured to form an empty section by holding back a transport unit.

Preferably, the second electrode string production device has a second electrode substrate providing device for providing a web-shaped second electrode substrate;
a second-electrode transport system having transport units individually movable along a guide track, the second-electrode transport system being configured to receive and move the web-shaped second electrode substrate provided by the second electrode-substrate providing device;
a second-electrode cutting device for cutting the second electrode substrate along a cutting contour to cut second electrodes from the second electrode substrate;
a second-separator web providing device for providing the second separator web; and
a second-electrode applying and fixing device for applying to and fixing second electrodes delivered by means of the second-electrode transport system in a manner positioned relative to each other on the second separator web.

Preferably, the first electrode string production device has a first-electrode substrate providing device for providing a web-shaped first electrode substrate;
a first-electrode transport system comprising transport units individually movable along a guide track, the first-electrode transport system being adapted to receive and move the web-shaped first electrode substrate provided by the first-electrode substrate providing device;
a first-electrode cutting device for cutting the first electrode substrate along a cutting contour to cut first electrodes from the first electrode substrate;
a first-separator web providing device for providing the first separator web; and
a first-electrode applying and fixing device for applying to and fixing first electrodes delivered by means of the first-electrode transport system in a manner positioned relative to each other on the first separator web.

Preferably, the battery cell stack production apparatus according to any one of the preceding embodiments comprises a controller configured to control the battery cell stack production apparatus for performing the battery cell stack production method according to any one of the preceding embodiments.

According to a further aspect, the invention provides a computer program comprising instructions that cause a battery cell stack production apparatus according to any one of the preceding embodiments to perform the battery cell stack production method according to any one of the preceding embodiments.

Preferred embodiments of the invention relate to a method for inline channeling of a half-cell into the stacking of battery cells with mono cells.

Embodiments of the invention are used in particular in the field of electromobility and there in particular in the mass production of batteries for electric vehicles.

The invention relates to the technical field of the production of battery cells. Battery cells are produced in particular by stacking mono-cells, which for example have a layer sequence separator (S)—anode (A)—separator (S)—cathode (K) or SASK for short. In some embodiments, mono-cells with the layer sequence SKSA can also be stacked on top of each other.

In the current state of the art, in some embodiments, the batteries terminate at both ends with a separator and anode arrangement in order to maximize capacity. In some battery designs, it may also be advantageous for the battery to terminate at both ends with a separator and cathode arrangement.

In the following, embodiments of the invention are described using the example of production from mono-cells with a layered structure SASK and with terminal cells with the layered structure SAS. To produce such mono-cells with SASK, an anode string is then provided as a first electrode string with a first web-shaped separator and anodes arranged at a distance therefrom (example for first electrodes), furthermore a cathode string is provided as a second electrode string with a second web-shaped separator and cathodes arranged at a distance therefrom (example for the second electrodes), these electrode strings are connected to form a composite string, then the mono-cells are separated therefrom and stacked. The production of mono-cells with SKSA layer structure with SKS terminal cells according to further embodiments of the invention takes place in an analogous manner, with the cathodes and the anodes merely interchanged.

During the normal production process, in the exemplary design, on the basis of which the embodiments of the invention are described in more detail, separator, cathode, separator, anode (SASK) or variations thereof are produced in the following sequence and stacked on top of each other to form battery cells.

In order to achieve the highest possible output, a continuous lamination process is used instead of a Z-folding process, which is also known for battery cell production.

Up to now, only SASK packs or their modifications have been produced in a closed system. A change in the sequence or the omission of the cathode is not yet known.

In order to provide a terminal cell as an SAS pack (separator, anode, separator), these would previously have to be produced in separate systems and fed to the mono-cell stack (SASK packs stacked on top of each other and their modifications) by means of complex handling as the end of the battery cell. This increases the effort and the minimum possible cycle time.

Embodiments of the invention enable (as yet unknown) inline SAS pack provision (or according to the alternative embodiments also inline SKS pack provision), which considerably reduces the cycle times and eliminates an additional partly manual logistical effort to provide these packs.

Preferred embodiments of the invention enable a (continuous) process that flexibly produces a complete battery stack, in particular including the provision of an SAS pack (or SKS pack) during the production process while maintaining a high output.

According to preferred embodiments of the invention, an additional handling step in which the SAS pack (or alternatively SKS pack) has to be picked up and put down again is avoided. For example, the cycle times are only 0.1 sec. per mono-cell (e.g. SASK), and an additional handling step is difficult to realize at this speed.

In preferred embodiments, by omitting a cathode in the production process as shown below, an SAS pack can be produced during the regular production process while utilizing the normal possible system speed. For this purpose, a flexible transport system with individually controlled movable transport units is preferably used, in which an intermediate region is used as a buffer for the required cathode track pieces. If an SAS pack is to be produced, a transport unit of the transport system is held back and no cathode is laminated to the separator, whereby an SAS pack is produced by lamination of the empty separator and the separator with the anode attached. In some designs, the web speed of the still unseparated cathode web is permanently lower than the web speed of the unseparated anode web, in order not to over-fill the buffer.

In preferred embodiments, a transport system with independently movable transport units is therefore used (such as a mover system with freely movable movers, as is available on the market from Beckhoff XTS, or a transport system from B & R Supertrack).

In preferred embodiments of the invention, for providing the first and the second electrode string, a transport system with independently movable transport units (such as a mover system with freely movable movers, such as is available on the market from Beckhoff XTS, or a transport system from B & R Supertrack) is used to pick up an electrode web (virtually endless) by vacuum and transport it to a separation point. Once the electrode web has been separated into sections, the flexible transport units create a freely adjustable gap between the individual electrode pieces.

After lamination of the first and second electrode strings (also known as half-cell strings) to form a composite string, the individual mono-cells are separated therefrom.

Depending on the stacking height of the mono-cells desired by the customer, the subsequent stacking process provides for a larger number of “discharge points” in order to insert the produced SAS packs into the mono-cell magazine as the first component of the battery cell. According to advantageous embodiments of the invention, the number of discharge points is selected to be large enough to compensate for gaps caused by defective mono-cells.

No additional systems are required to produce SAS packets. There is also no need for complex logistics for distributing SAS magazines. There is no need to feed SAS packs into a running process via grippers, for example.

### BRIEF DESCRIPTION OF THE DRAWINGS

An exemplary embodiment is explained in more detail below with reference to the attached drawings. In the drawings:

FIG. 1 is a schematic overview of an embodiment of a battery cell stack production apparatus for the production of a battery cell stack from a first electrode string and a second electrode string; and

FIG. 2 is a schematic overview of an embodiment of a stacking device of the battery cell stack production apparatus.

### DETAILED DESCRIPTION OF THE PREFERRED EMBODIMENTS

In the following, with reference to the accompanying drawings, methods and apparatuses for producing a battery cell stack 22 from mono-cells 86 are described. In this case, the mono-cells 86 are separated from a cell composite string—hereinafter also simply referred to as composite string 88—which is formed by combining a first and second electrode string 32.1, 32.2.

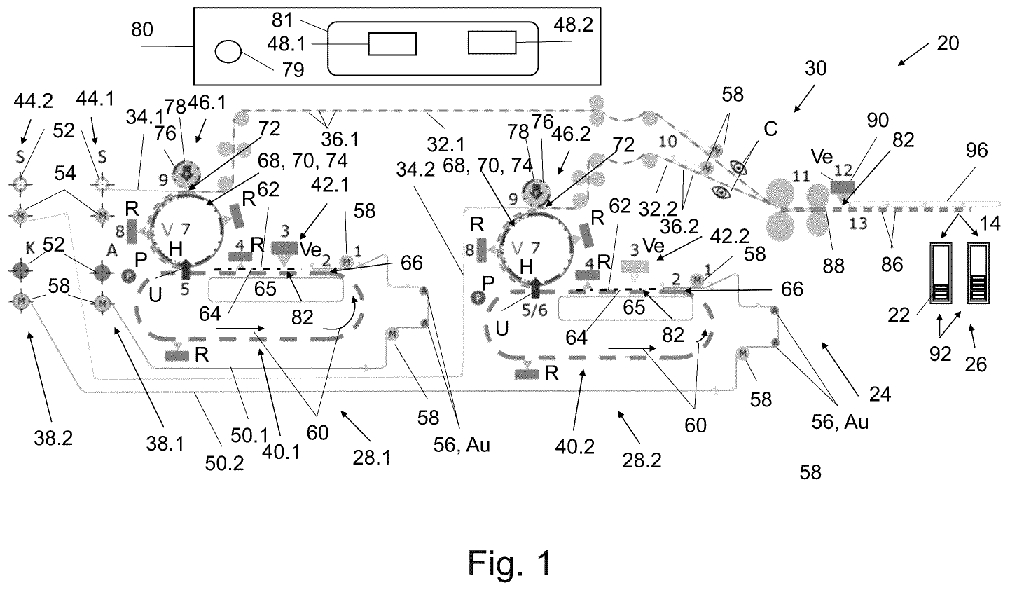

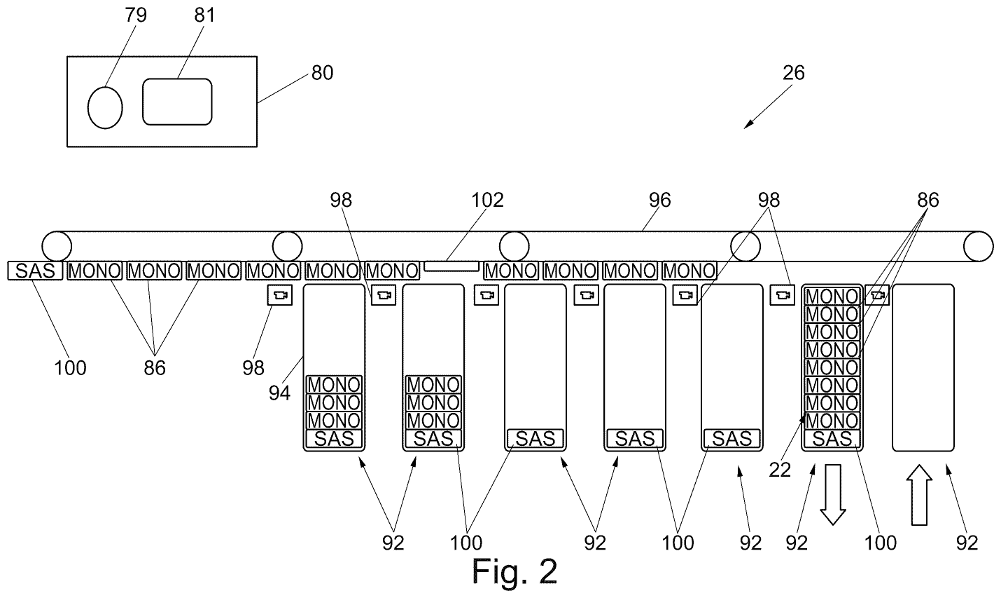

FIG. 1 shows an example of a battery cell stack production apparatus 20 for the production of a battery cell stack 22. The cell stack production apparatus 20 comprises a mono-cell production apparatus 24, a stacking device 26 and a controller 80. FIG. 2 shows an example of the stacking device 26.

The mono-cell production apparatus 24 comprises a first electrode string production device 28.1, a second electrode string production device 28.2, a string connecting device 30 and a cell composite separating device 90.

The respective electrode string production device 28.1, 28.1 is used in each case to produce an electrode string 32.1, 32.2 which includes a separator web 34.1, 34.2 and electrode segments 36.1, 36.2 attached thereto at a distance from one another. The computer-controlled first electrode string production device 28.1 is configured to attach first electrodes 36.1, such as anodes A, to a first separator web 34.1 at a predetermined distance from each other to form a series of successive first electrode half-cell sections having a predetermined length, so that each first electrode half-cell section is formed from a length section of the first separator web 34.1 and a first electrode 36.1. The computer-controlled second electrode string production device 28.2 is designed to attach to a second separator web 34.2 second electrodes 36.2, which are counter electrodes to the first electrodes 36.1, such as cathodes K, at a predetermined distance from one another in order to form a series of second electrode half-cell sections with the same predetermined length as the first electrode half-cell sections, so that each second electrode half-cell section is formed from a length section of the second separator web 34.2 and a second electrode 36.2.

The structure of the first and second electrode string production apparatus 28.1, 28.2 is essentially the same and is described below only once using the example of one of the first and second electrode string production apparatuses 28.1, 28.2.

The electrode string production apparatus 28.1, 28.2 has an electrode substrate providing device 38.1, 38.2, a transport system 40.1, 40.2, a cutting device 42.1, 42.2, a separator web providing device 44.1, 44.2, an application and fixing device 46.1, 46.2 and a control unit 48.1, 48.2.

The electrode substrate providing device 38.1, 38.2 is designed to provide a web-shaped electrode substrate 50.1, 50.2. For example, the electrode substrate supply device 38.1, 38.2 has a roll holder for a supply roll 52 with the respective web-shaped electrode substrate 50.1, 50.2, a drive 58 or motor for accelerating the supply roll 52 and at least one measuring roll (not shown), over which the web-shaped electrode substrate 50.1, 50.2 is passed and which detects the unwinding length and/or the unwinding speed at which the web-shaped electrode substrate 50.1, 50.2 is unwound and provided and feeds corresponding information to the control unit 48.1, 48.2.

In addition, in the embodiments shown, the electrode substrate providing device 38.1, 38.2 has an electrode substrate delivery device which comprises alignment elements 56, such as rollers, and a drive 58 for driving the movement of the web-shaped electrode substrate 50.1, 50.2.

The transport system 40.1, 40.2 has transport units 62 individually movable along a circumferential guide track 60. The movement of the individual transport units 62 can be controlled individually by the control unit 48.1, 48.2. The transport system 40.1, 40.2 configured to pick up the web-shaped electrode substrate 50.1, 50.2 provided by the electrode substrate providing device 38.1, 38.2 and to move it along a cutting plane 64.

For example, the guide track 60 has a rectilinear region adjacent to a pick-up point 66, so that the surfaces of workpiece carriers of the transport units 62, where the electrode substrate 50.1, 50.2 rests on and is fixed by means of vacuum or grippers (not shown) for example, move along the cutting plane 64. Here, 65 denotes the region of the electrode fixation where the electrode substrate 50.1, 50.2 and the electrode segments separated therefrom are fixed on the transport units 62.

In some embodiments, the workpiece carriers attached to the transport units 62 run past an air duct in the region of the electrode fixation 65, which air duct is connected to a vacuum source (not shown). In other embodiments, a respective vacuum pump, e.g. designed as a diaphragm pump, is arranged on each of the transport units 62, which vacuum pumps are connected to air connections of the workpiece carrier by means of valves that can be controlled by the control unit 48.1, 48.2. Air circuits of the workpiece carriers are thus supplied with vacuum to fix the electrode segments 36.1, 36.2 in this region of the electrode fixation 65 to the transport units 62.

Accordingly, in the embodiments shown, the transport system 40.1, 40.2 is configured to hold the electrode substrate 50.1, 50.2 in the web-like and/or the separated form specifically by means of vacuum (or alternatively also by other means, such as grippers) on the individual transport units 62 for transporting and cutting.

As mentioned above, the movement of the transport units 62 is individually controllable. In some embodiments, the transport system 40.1, 40.2 has means implemented as software for this purpose, in particular in the control unit 48.1, 48.2, for adjusting a distance between cut electrode segments 36.1, 36.2 by relative movement of the transport units 62 in order to position the electrode segments 36.1, 36.2 relative to one another.

The cutting device 42.1, 42.2 is designed to cut the electrode substrate 50.1, 50.2 along a cutting contour extending in one or two dimensions in the cutting plane 64 in order to cut the electrodes 36.1, 36.2 from the electrode substrate 50.1, 50.2. For example, the cutting device 42.1, 42.2, as is known in principle from [1], has a cutting laser with corresponding deflection units that are controlled by the control unit 48.1, 48.2 in order to direct the laser beam along the cutting contour.

The cutting device 42.1, 42.2 is configured for cutting on the flat surface. The cutting contour of the cutting device 42.1, 42.2 is designed to shape the side edges of the respective electrode 36.1, 36.2. In particular, outgoing conductor lugs can also be formed on at least one side edge of the electrode 36.1, 36.2 during cutting. This can be done by performing a two-dimensional laser cut within the cutting plane 64.

The separator web providing device 44.1, 44.2 is configured to provide the separator web 34.1, 34.2. Analogous to the electrode substrate providing device 38.1, 38.2, it can for example have a supply roller 52 with the separator web 34.1, 34.2, a drive 58 and a measuring roller (not shown), the signals of which are also transmitted to the control unit 48.1, 48.2.

The application and fixing device 46.1, 46.2 is designed for applying to and fixing electrodes 36.1, 36.2 delivered by means of the transport system 40.1, 40.2 in a manner positioned relative to one another on the separator web 34.1, 34.2.

In some embodiments, the application and fixing device 46.1, 46.2 has a heating device 68 for targeted heating of the electrodes 36.1, 36.2. In some embodiments, the application and fixing device 46.1, 46.2 has a transport device 70 for transporting and lifting the electrodes 36.1, 36.2 positioned relative to one another from the transport units 62 to a laminating point 72.

In the embodiments shown, a vacuum heating roller 74 is provided as the transport device 70 with heating device 68, the surface of which can be selectively heated by an integrated heater and is provided with suction openings in order to suck the electrodes 36.1, 36.2. Alternatively, a temperature-controlled roller or an externally temperature-controlled vacuum roller can also be provided.

In some embodiments, the application and fixing device 46.1, 46.2 further comprises a preferably uncoated laminating roller 76, which is pressed onto the transport device 70 at the pressing force of a pressing device 78, in particular the vacuum heating roller 74, in order to laminate the electrode segments 36.1, 36.2 onto the separator web 34.1, 34.2 provided by the separator web providing device 44.1, 44.2.

In the embodiments shown, the laminating roller 76 is driven in a controlled manner by the control unit 48.1, 48.2. In some embodiments, this also drives the movements of the vacuum heating roller 74 and the separator web 34.1, 34.2. In other embodiments, the vacuum heating roller 74 is driven to rotate in a controlled manner by the control unit. Further drives may also be provided to drive the movement of the separator web 34.1, 34.2. In some embodiments, the laminating roller 76 may be designed without a drive.

Accordingly, in the illustrated embodiments of the mono-cell production apparatus 24, the first electrode string production device 28.1 serves to produce an anode string provided with anodes A as first electrodes 36.1, and the second electrode string production device 28.2 serves to produce an anode string provided with cathodes K as second electrodes 36.2.

The computer-controlled string connecting device 30 is adapted to form the cell composite string 88 by aligning and attaching the first electrode string 32.1 and the second electrode string 32.2 to each other such that a first electrode half-cell section and a second electrode half-cell section are superposed on each other in successive length sections in the cell composite string 88 to form a series of mono-cell regions each having a layered structure of a length section of one of the first and second separator webs 34.1, 34.2, one of the first and second electrodes 36.1, 36.2, a length section of the other of the first and second separator webs 34.2, 34.1 and the other of the first and second electrodes 36.1, 36.2. In the embodiment shown, mono-cell regions are created with the layer structure SASK; in other embodiments (not shown), mono-cell regions can also be created with the layer structure SKSA.

Specifically, the string connecting device 30 is configured to connect the anode string and the cathode string to form the composite string 88 with anodes and cathodes aligned with one another and lying on top of one another.

The separating device 90 is provided for separating cells 86, 100 by cutting them off from the composite string 88.

The stacking device 26 is configured for stacking a plurality of cells 86, 100 produced by the mono-cell production device 24 to form a battery cell stack 22.

As can be seen in particular in FIG. 2, the computer-controlled stacking device 26 has a plurality of stacking locations 92, which are arranged one behind the other in a transport direction of the cells 86, 100. Exchangeable product carriers 94 can be attached to the stacking locations 92, which product carriers receive the battery cell stacks 22 and can be exchanged after filling. In the embodiment shown, a conveyor belt 96, here in the form of a vacuum belt, is also provided, which conveyor belt delivers the cells 86, 100 to the stacking locations 92 and from which the cells 86, 100 are discharged for stacking.

Furthermore, the stacking device 26 has a cell detection and counting device 98 for detecting the number of cells at one or more stacking locations. This is shown only schematically in FIG. 2 and comprises for example an image capture with an evaluation unit which preferably records the number of cells 86, 100 dropped at each stacking location 92.

The controller 80 is configured to control the battery cell production apparatus 20 for carrying out the battery cell stacking method explained below.

The controller 80 includes a processor 79 and a memory 81 with a computer program stored therein, the latter containing corresponding instructions causing the units of the battery cell stack production apparatus 20 to carry out this battery cell stack production method.

The battery cell stack production method for the production of battery cell stacks comprises the following steps a) to e):
a) producing the first electrode string 32.1, wherein first electrodes 36.1 are fixed to the first separator web 34.1 at a predetermined distance from each other to form a series of successive first electrode half-cell sections having a predetermined length, so that each first electrode half-cell section is formed of a length section of the first separator web 34.1 and a first electrode 36.1,
b) producing the second electrode string 32.2, wherein second electrodes 36.2, which are counter electrodes to the first electrodes 36.1, are fixed to the second separator web 34.2 at a predetermined distance from each other to form a series of second electrode half-cell sections having the same predetermined length as the first electrode half-cell sections, so that each second electrode half-cell section is formed of a length section of the second separator web 34.2 and a second electrode 36.2,
c) forming the cell composite string 88 by aligning and attaching the first electrode string 32.1 and the second electrode string 32.2 to each other such that a first electrode half-cell section and a second electrode half-cell section are superimposed in successive length sections in the cell composite string 88 to form a series of mono-cell regions each having a layered structure of a length portion of one of the first and second separator webs 34.1, 34.2, one of the first and second electrodes 36.1, 36.2, a length section of the other of the first and second separator webs 34.1, 34.2 and the other of the first and second electrodes 36.1, 36.2,
d) separating the length sections of the cell composite string 88 to separate the mono-cell regions into mono-cells 86 having a layered structure of separator S, one of the first and second electrodes 36.1, 36.2, separator S and the other of the first and second electrodes 36.1, 36.2, and
e) stacking a plurality of mono-cells 86 on top of each other to form a battery cell stack 22 with repeating layer structure separator S—one of the first and second electrodes 36.1, 36.2—separator S—other of the first and second electrodes 36.1, 36.2.

For inline feeding of terminal cells 100—for example, one SAS pack each as a terminal cell of a battery cell stack 22 formed from SASK mono-cells—the following sub-step is carried out when performing step b)—production of the second electrode string 32.2:
b1) omitting a second electrode 36.2 at several locations, so that in each case an empty section with the same predetermined length as the first electrode half-cell section is formed, the empty section being formed of a length section of the second separator web 34.1 without a second electrode.

When carrying out step c)—forming the cell composite string—the following sub-step is carried out:
c1) aligning each empty section with a first electrode half-cell section, so that a terminal cell region is produced in the cell composite string at each of the multiple locations, which terminal cell region has a layered structure comprising the length section of the first separator web 34.1, the first electrode 36.2 and the length section of the second separator web 34.2, but no second electrode.

When carrying out step d), the following sub-step is carried out:
d1) separating the terminal cell regions from the composite cell string 88 to obtain terminal cells 100 having a layered structure of separator S, first electrode 36.1 and separator S.

And when performing step e), the following sub-step is performed:

Beginning or terminating stacking with a terminal cell 100 obtained in step d1), so that each battery cell stack 22 terminates at each end with a first electrode 36.1 and a separator S.

In the embodiments shown in the Figures, the first electrodes 36.1 are anodes and the second electrodes 36.2 are cathodes, and mono cells 86 with a SASK layered structure and terminal cells 100 with a SAS layered structure are produced. Each stacking of a new battery cell stack 22 at one of the stacking locations 92 then begins with a terminal cell 100 such that the bottom portions of the stacks have an SAS-KSAS-KSAS- . . . structure when viewed from bottom to top, and the top portions of the completed stacks have a . . . KSAS-KSAS structure when viewed from bottom to top. In other embodiments not shown, the first electrodes 36.1 are cathodes and the second electrodes 36.2 are anodes, the stacking begins again with a terminal cell 100, and the result is a layered structure SKS-ASKS-ASKS . . . -ASKS-ASKS seen from bottom to top. In other embodiments, it is also possible to begin with a mono-cell 86 with the separator directed downwards and terminate with a terminal cell 100, resulting in this case in a layered structure SASK-SASK- . . . SASK-SAS or alternatively SKSA-SKSA- . . . SKSA-SKS, viewed from bottom to top.

Specific preferred embodiments of the battery cell stack production method are shown in FIGS. 1 and 2. The following process steps are illustrated:
1 feeding electrodes and separators as web material into the cutting and laminating process
2 mounting the web on a transport system with flexibly movable carriers for the separated electrodes
3 separating the electrode webs for both the anode and the cathode
4 optionally cleaning the electrodes transferring the electrodes to the vacuum roller
6 if required, an electrode can optionally be omitted for the provision of a terminal cell, for example an SAS pack
7 heating the electrodes
8 optionally cleaning the electrodes
9 laminating the half-cells to form two half-cell strings
combining the half-cell strings
11 laminating the two half-cell strings to form a mono cell string
12 separating the mono cells or terminal cells
13 transferring the mono-cells or terminal cells to a conveyor belt for further processing
14 stacking the mono cells to form a battery cell stack
The symbols used in FIG. 1 have the following meaning:
U transfer Lamination
R cleaning
Ve separation
C control
M drive
Au alignment
P (paper winder/trash can autosplice)
H heating
V vacuum
S separator
K cathode(substrate)
A anode(substrate)

At 6, a gap is generated in the cathode string for the provision of an SAS pack (example for a final cell 100) by omitting a cathode during the transfer to the vacuum heating roller 74. The resulting gap in the cathode string can be used to provide a half cell in SAS format (anode enclosed in 2 separators). Utilization of the normal possible system speed remains possible by using the flexible transport system 40.2 for this purpose, in which the space under the optional electrode cleaning system 4 is used as a buffer for transport units 62 with cathode web pieces located on them. If an SAS pack is to be produced, the transport unit 62 is held back and no cathode is laminated to the separator, whereby an SAS pack is produced by the lamination of the empty separator and the separator with adhering anode. For this purpose, the web speed of the still unseparated cathode web is permanently lower than the web speed of the unseparated anode web so as not to over-fill the buffer.

A specific example of the stacking process 14 is described below using the illustration in FIG. 2.

From the upstream process (see FIG. 1) of mono-cell or half-cell production, the mono-cell/SAS packs are transferred to the conveyor belt (vacuum belt) 96. The stacking positions 92 are always filled first with an SAS pack—terminal cell 100—and then filled with mono cells 86. Any gaps that may occur due to defective cells 102, which are detected in the progression of the system—see symbol C control—are taken into account so as not to generate any additional manual effort. The following parameters are coordinated for this purpose:
production of the terminal cells 100—depending on the filling level of the stacking stations 92;
outfeeding of defective cells 102, e.g. defective mono cells 86;
distance between lamination process and discharge points (affects the controllability and the number of required discharge points)
stacking process (number of cells in each stack is tracked)
number of discharge points (sufficient for high cycle times, as changeover times of the product carriers 94 must be taken into account as well as buffering in the event of gaps due to defective cells 102).

In order to produce battery cell stacks (22) in industrial mass production with very fast cycle times and low effort in such a way that the two ends of the battery cell stack (22) terminate with the same type of electrode (A or K) and a separator (S), methods and apparatuses (20) have been proposed for the production of battery cell stacks (22) in which a first and second electrode string (32.1, 32.2) with separator web (34.1, 34.2) and first and second electrodes (36.1, 36.2) arranged at a distance therefrom are combined into a composite string (88) and mono-cells (86) are separated therefrom. To form terminal cells (100), a second electrode (36.2) is omitted at some points during the production of the second electrode string (32.2), so that a length section of the respective separator web (34.2) is produced without the corresponding second electrode. A terminal cell region is then formed in the composite string (88), in which a first electrode (36.1) is inserted between separator web length sections. This is separated when the cells (86, 100) are separated from the composite string (88) to form a terminal cell (100). Subsequent stacking can then begin or terminate with terminal cell (100).

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 feeding electrodes and separators as web material into the cutting and laminating process
2 mounting the web on a transport system with flexibly movable carriers for the separated electrodes
3 separating the electrode webs for both the anode and the cathode
4 optionally cleaning the electrodes
5 transferring the electrodes to the vacuum roller
6 if required, an electrode can be omitted for the provision of a terminal cell, for example an SAS pack
7 heating the electrodes
8 optionally cleaning the electrodes
9 laminating the half-cells to form two half-cell strings
10 combining the half-cell strings
11 laminating the two half-cell strings to form a mono cell string
12 separating the mono cells
13 transferring the mono-cells to a conveyor belt for further processing
14 stacking the mono cells to form a battery cell stack
15 battery cell stack production apparatus
22 battery cell stack
24 mono cell production apparatus
26 stacking device
28.1 first electrode string production apparatus
28.2 second electrode string production apparatus
30 string connecting device
32.1 first electrode string
32.2 second electrode string
34.1 first separator web
34.2 second separator web
36.1 first electrode
36.2 second electrode
38.1 first electrode substrate providing device
38.2 second electrode substrate providing device
40.1 first-electrode transport system
40.2 second-electrode transport system
42.1 first-electrode cutting device
42.2 second-electrode cutting device
44.1 first separator web providing device
44.2 second separator web providing device
46.1 first electrode application and fixing device
46.2 second electrode application and fixing device
48.1 first control unit
48.2 second control unit
50.1 web-shaped first-electrode substrate
50.2 web-shaped second-electrode substrate
52 supply roller
54 measuring roller
56 alignment element
58 drive
60 guide track
62 transport unit
64 cutting plane
65 electrode fixation
66 pick-up point
68 heating device
70 transport unit
72 laminating point
74 vacuum heating roller
76 laminating roller
78 pressing device
79 processor
80 control unit
81 memory
82 separating point
86 mono cell
88 composite string
90 separating device
92 stacking location
94 product carrier
96 conveyor belt
98 cell detecting and counting device
100 terminal cell
102 defective cell
U lamination transfer
R cleaning
Ve separation
C control
M drive
Au alignment
P (paper winder/trash can autosplice)
H heating
V vacuum
S separator
K cathode(substrate)
A anode(substrate)

Claimed is:

1. A method for producing a battery cell stack, the method comprising:
a) producing a first electrode string, wherein first electrodes are fixed to a first separator web at a predetermined distance from each other to form a series of successive first electrode half-cell sections having a predetermined length, such that each first electrode half-cell section is formed of a length section of the first separator web and a first electrode,
b) producing a second electrode string, wherein second electrodes, which are counter-electrodes to the first electrodes, are fixed on a second separator web at a predetermined distance from each other to form a series of second electrode half-cell sections having the same predetermined length as the first electrode half-cell sections, so that each second electrode half-cell portion is formed of a length section of the second separator web and a second electrode,
c) forming a cell composite string by aligning and attaching the first electrode string and the second electrode string to each other such that in successive length sections in the cell composite string a first electrode half-cell section and a second electrode half-cell section are superimposed to form a series of mono-cell regions each having a layered structure of a length section of one of the first and second separator webs, one of the first and second electrodes, a length section of the other of the first and second separator webs and the other of the first and second electrodes,
d) separating the length sections of the cell composite string to separate the mono-cell regions into mono-cells having a layered structure of separator, one of the first and second electrodes, separator and the other of the first and second electrodes, and
e) stacking a plurality of mono-cells on top of each other to form a battery cell stack having a repeating layered structure of separator—one of the first and second electrodes—separator—other of the first and second electrodes,
wherein step b) comprises b1) omitting a second electrode at several locations, so that in each case an empty section with the same predetermined length as the first electrode half-cell section is produced which is formed of a length section of the second separator web without a second electrode,
wherein step c) comprises c1) aligning each empty section with a first electrode half-cell section, so that a terminal cell region is formed in the cell composite string at each of the several locations which has a layered structure of the length section of the first separator web, the first electrode and the length section of the second separator web, but without a second electrode,
wherein step d) comprises d1) separating the terminal cell regions from the cell composite string to obtain terminal cells having a layered structure of separator, first electrode and separator, and,
wherein step e) comprises beginning or terminating stacking with a terminal cell obtained in step d1), so that each battery cell stack terminates at each end with a first electrode and a separator.

2. The method according to claim 1, wherein that step e) further comprises at least one or more of the steps:
e1) forming a plurality of battery cell stacks at a plurality of stacking locations arranged one behind the other in a transport direction of the mono and terminal cells;
e2) beginning each battery cell stack with a terminal cell;
e3) detecting a number of cells at each stacking location.

3. The method according to claim 1, wherein step b1) further comprises at least one or more of the steps:
b1a) flexibly generating an empty section in response to a control command;
b1b) generating empty sections depending on a number of cells in one or more of the battery cell stacks created in step e);
b1c) generating empty sections depending on a filling level of stacking locations.

4. The method according to claim 1, wherein step b) further comprises providing the second electrodes by separating the second electrodes from a web-shaped second-electrode substrate and that step a) comprises providing the first electrodes by separating the first electrodes from a web-shaped first-electrode substrate and that a speed at which the web-shaped second-electrode substrate is delivered to provide the second electrodes is lower than a speed at which the web-shaped first-electrode substrate is delivered to provide the first electrodes.

5. The method according to claim 1, wherein step b) further comprises b2) providing the second electrodes with a flexible second-electrode transport system which has transport units which can be moved individually along a guide track and on each of which a second electrode is transported, and
wherein step b1) further comprises b2.1) holding back a transport unit to form the empty section.

6. The method according to claim 5, wherein step b) further comprises the following sequence of steps:
b-a) providing a web-shaped second-electrode substrate;
b-b) picking up the web-shaped second-electrode substrate with the second-electrode transport system and transporting the second-electrode substrate to a second-electrode cutting device;
b-c) cutting the web-shaped second-electrode substrate in the second-electrode cutting device to cut off the second electrodes, each of which is individually arranged on one of the transport units;
b-d) adjusting a distance between cut second electrodes with a relative movement of the transport units to position the second electrodes relative to each other;
b-e) providing the second separator web;
b-f) applying to and fixing the second electrodes positioned relative to each other on the second separator web.

7. The method according to claim 1, wherein step a) comprises the following sequence of steps:
a-a) providing a web-shaped first-electrode substrate;
a-b) picking up the web-shaped first-electrode substrate with a flexible first-electrode transport system which has transport units configured to be moved individually along a guide track, and transporting the first-electrode substrate to a first-electrode cutting device;
a-c) cutting the web-shaped first-electrode substrate in the first-electrode cutting device to cut off the first electrodes, each of which is individually arranged on one of the transport units of the first-electrode transport system;
a-d) adjusting a distance between cut first electrodes with a relative movement of the transport units to position the first electrodes relative to each other;
a-e) providing the first separator web;
a-f) applying to and fixing the first electrodes positioned relative to each other on the first separator web.

8. The method according to claim 1, wherein the first electrodes are anodes and the second electrodes are cathodes, or
wherein the first electrodes are cathodes and the second electrodes are anodes.

9. An apparatus for producing battery cell stacks, the apparatus comprising:
a computer-controlled first electrode string production device for producing a first electrode string which is configured to attach to a first separator web first electrodes at a predetermined distance from one another to form a series of successive first electrode half-cell sections of a predetermined length, so that each first electrode half-cell section is formed of a length section of the first separator web and a first electrode,
a computer-controlled second electrode string production device for producing a second electrode string which is configured to attach to a second separator web second electrodes, which are counter-electrodes to the first electrodes, at a predetermined distance from each other to form a series of second electrode half-cell sections having the same predetermined length as the first electrode half-cell sections, so that each second electrode half-cell section is formed of a length section of the second separator web and a second electrode,
a computer-controlled string connecting device which is configured to form a cell composite string by aligning and attaching the first electrode string and the second electrode string in such a way that a first electrode half-cell section and a second electrode half-cell section are superimposed in successive length sections in the cell composite string in order to form a series of mono-cell regions, each of which has a layer structure comprising a length section of one of the first and second separator webs, one of the first and second electrodes, a length section of the other of the first and second separator webs and the other of the first and second electrodes,
a cell composite separating device for separating the length sections of the cell composite string to separate the mono-cell regions into mono-cells having a layered structure of separator, the one of the first and second electrodes, separator and the other of the first and second electrodes, and
a computer-controlled stacking device configured to stack a plurality of mono-cells on top of each other to form a battery cell stack having a repeating layered structure of separator—one of the first and second electrodes—separator—other of the first and second electrodes,
wherein the second electrode string production device is configured to omit a second electrode at a plurality of locations, so that in each case an empty section with the same predetermined length as the first electrode half-cell section is created which is formed of a length section of the second separator web without a second electrode,
wherein the string connecting device is configured to align each empty section with a first electrode half-cell section, so that in the cell composite string a terminal cell region is produced at each of the multiple locations, which has a layered structure of the length section of the first separator web, the first electrode and the length section of the second separator web, but no second electrode,
wherein the cell composite separating device is configured to separate the terminal cell regions from the cell composite string in order to obtain terminal cells which have a layered structure of separator, first electrode and separator, and
wherein the stacking device is configured to begin or terminate the stacking of each cell stack with a terminal cell, so that each battery cell stack terminates at each end with a first electrode and a separator.

10. The apparatus according to claim 9, wherein the stacking device has a plurality of stacking locations which are arranged one behind the other in a transport direction of mono and terminal cells,
wherein the stacking device has a cell detection and counting device for detecting a number of cells at one or more stacking locations, or
both.

11. The apparatus according to claim 9, wherein the second electrode string production device is configured to: flexibly generate an empty section in response to a control command, generate empty sections depending on a number of cells in one or more of the battery cell stacks formed by the stacking device; or generate empty sections depending on a filling level of stacking locations of the stacking device, or a combination thereof; or
wherein the first electrode string production device has a first electrode web delivery device for delivering a web-shaped first-electrode substrate and the second electrode string production device has a second electrode web delivery device for delivering a web-shaped second-electrode substrate, wherein the first electrode string production device and the second electrode string production device are controlled such that the first-electrode substrate is delivered at a higher speed than the second-electrode substrate; or
both.

12. The apparatus according to claim 9, wherein the second electrode stack production device comprises a flexible second-electrode transport system with transport units individually movable along a guide track for transporting a second electrode in each case and is configured to form an empty section by holding back a transport unit.

13. The apparatus according to claim 9, wherein the second electrode string production device comprises:
a second-electrode substrate providing device for providing a web-shaped second-electrode substrate;
a second-electrode transport system comprising transport units individually movable along a guide track, wherein the second-electrode transport system is configured to pick up and move the web-shaped second-electrode substrate provided by the second-electrode substrate providing device;
a second-electrode cutting device for cutting the second-electrode substrate along a cutting contour to cut second electrodes from the second-electrode substrate;
a second-separator web providing device for providing the second-separator web; and
a second-electrode applying and fixing device for applying to and fixing second electrodes delivered with the second-electrode transport system positioned relative to each other on the second separator web.

14. The apparatus according to claim 9, wherein the first electrode string production device comprises:
a first-electrode substrate providing device for providing a web-shaped first-electrode substrate;
a first-electrode transport system having transport units individually movable along a guide track, wherein the first-electrode transport system is configured to pick up and move the web-shaped first-electrode substrate provided by the first-electrode substrate providing device;
a first-electrode cutting device for cutting the first-electrode substrate along a cutting contour to cut first electrodes from the first-electrode substrate;
a first-separator web providing device for providing the first-separator web; and
a first-electrode applying and fixing device for applying to and fixing first electrodes supplied by the first-electrode transport system in a manner positioned relative to each other on the first separator web.

15. The battery cell stack production apparatus according to claim 9, further comprising:
a controller configured to control the apparatus.

16. A non-transitory computer readable media storing a computer program comprising instructions that configured to cause a battery cell stack production apparatus to perform the method according to claim 1.
